(19) United States
(12) Patent Application Publication
(10) Pub. No.: US 2024/0067816 A1
(43) Pub. Date: Feb. 29, 2024

(54) THERMOPLASTIC VULCANIZATE AND PREPARATION METHOD THEREOF

(71) Applicant: INDUSTRIAL TECHNOLOGY RESEARCH INSTITUTE, Hsinchu (TW)

(72) Inventors: Jin-An WU, Hsinchu City (TW); Fu-Ming CHIEN, Hsinchu City (TW); Yun-Chen CHANG, Taichung City (TW)

(73) Assignee: INDUSTRIAL TECHNOLOGY RESEARCH INSTITUTE, Hsinchu (TW)

(21) Appl. No.: 18/317,979

(22) Filed: May 16, 2023

Related U.S. Application Data
(60) Provisional application No. 63/400,137, filed on Aug. 23, 2022.

(30) Foreign Application Priority Data
Dec. 22, 2022 (TW) 111149369

(51) Int. Cl. C08L 67/02

(52) U.S. Cl. CPC C08L 67/02; C08L 2205/035

(57) ABSTRACT

A thermoplastic vulcanizate is provided. The thermoplastic vulcanizate includes: (A) about 100 parts by weight of a styrene copolymer rubber; (B) about 40-90 parts by weight of a thermoplastic elastomer; (C) about 5-15 parts by weight of an interfacial compatible resin; and (D) about 0.2-3 parts by weight of a cross-linking formulation, wherein the content of component (A) is greater than the content of component (B). Component (A) is dispersed in component (B) in the form of particles with a particle size of about 0.5-10 μm.

### CROSS REFERENCE TO RELATED APPLICATIONS

This application claims the benefit of U.S. Provisional Application No. 63/400,137, filed on Aug. 23, 2022, and priority of Taiwan Patent Application No. 111149369, filed on Dec. 22, 2022, the entirety of which are incorporated by reference herein.

### BACKGROUND OF THE INVENTION

### Field of the Invention

The present disclosure relates to an elastomer and a preparation method thereof, and, in particular, to a thermoplastic vulcanizate and a preparation method thereof.

### Description of the Related Art

Thermoplastic vulcanizates (TPV) have thermoplasticity, processability, elasticity, and compressibility. These thermoplastic vulcanizates can be processed multiple times. Compared to conventional thermosetting rubbers, the thermoplastic vulcanizates are recyclable. It is therefore desirable to replace the thermosetting rubbers with thermoplastic vulcanizates. A conventional thermoplastic vulcanizate is mainly composed of polypropylene/ethylene propylene diene monomer (PP/EPDM). However, a conventional thermoplastic vulcanizate has poor wear resistance and anti-slip performance, and material surfaces thereof have low polarity.

A conventional athletic shoe structure includes a shoe upper component, a midsole component, an outsole component, and an adhesive component that connects the shoe upper component, the midsole component, and the outsole component together. A conventional midsole component is made of ethylene/vinyl acetate copolymers (EVA). The ethylene/vinyl acetate copolymers are polar substances. The outsole component comprising the conventional thermoplastic vulcanizate and the midsole component comprising the ethylene/vinyl acetate copolymers may not adhere together firmly due to the polarity difference between them.

### BRIEF SUMMARY OF THE INVENTION

The disclosure provides a novel thermoplastic vulcanizate and a preparation method thereof.

An embodiment of the present disclosure provides a thermoplastic vulcanizate including: (A) about 100 parts by weight of a styrene copolymer rubber; (B) about 40-90 parts by weight of a thermoplastic elastomer; (C) about 5-15 parts by weight of an interfacial compatible resin; and (D) about 0.2-3 parts by weight of a cross-linking formulation, wherein the content of component (A) is greater than the content of component (B). Component (A) is dispersed in component (B) in the form of particles with a particle size of about 0.5-10 μm.

Another embodiment of the present disclosure provides a preparation method of a thermoplastic vulcanizate, comprising the following steps: preparing a first mixture, wherein the first mixture comprising a styrene copolymer rubber and a cross-linking formulation; performing an extrusion granulation process to form a first mixture particle from the first mixture; mixing a thermoplastic elastomer, an interfacial compatible resin, and the first mixture particle to form a second mixture, wherein in parts by weight, the content of the rubber in the first mixture particle is more than that of the thermoplastic elastomer; and performing a dynamic cross-linking process to form a thermoplastic vulcanizate from the second mixture, wherein the dynamic cross-linking process is performed at a reaction temperature of about 170-200° C. and a screw speed of about 150-300 rpm.

### BRIEF DESCRIPTION OF THE DRAWINGS

The present disclosure can be more fully understood by reading the subsequent detailed description and examples with references made to the accompanying drawings, wherein:

FIG. 1 is a flowchart of a preparation method of a thermoplastic vulcanizate according to an embodiment of the present disclosure; and

FIG. 2 is a SEM image of a thermoplastic vulcanizate according to an embodiment of the present disclosure.

### DETAILED DESCRIPTION OF THE INVENTION

The term “about” “as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, the term “about” can mean within one or more standard deviations, or within ±30%, 20%, 10%, 5% of the stated value. The value given here are approximate value, i.e., “about”, “approximate”, or “rough” may be implied without specifying “about”, “approximate”, or “rough”. It will be understood that the expression “a-b” used herein to indicate a specific range including values greater than or equal to a and less than or equal to b.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Some embodiments of the disclosure are described below. Additional operations can be provided before, during, and/or after the stages described in these embodiments. Some of the stages that are described can be replaced or eliminated for different embodiments. Although some embodiments are discussed with operations performed in a particular order, these operations may be performed in another logical order.

An embodiment of the present disclosure provides a thermoplastic vulcanizate including: (A) about 100 parts by weight of a styrene copolymer rubber; (B) about 40-90 parts by weight of a thermoplastic elastomer; (C) about 5-15 parts by weight of an interfacial compatible resin; and (D) about 0.2-3 parts by weight of a cross-linking formulation, wherein the content of component (A) is greater than the content of component (B). In some embodiment, the thermoplastic vulcanizate may further include about 5-50 parts by weight of an additive as component (E). In some embodiments, the thermoplastic vulcanizate may further include about 0-20 parts by weight of a non-aromatic rubber as component (F). In some embodiments, in the thermoplastic vulcanizate, the weight ratio of component (A) to component (F) is about 8-10:0-2. In some embodiments, the weight ratio of component (A) to component (F) is about 9:1.

In some embodiments, based on 100 parts by weight of component (A), the thermoplastic vulcanizate may include about 40-90 parts by weight, about 50-85 parts by weight, about 60-84 parts by weight, about 70-83.5 parts by weight, about 75 parts by weight, or about 90 parts by weight of component (B). In some embodiments, based on 100 parts by weight of component (A), the thermoplastic vulcanizate may include about 5-15 parts by weight, about 8-12 parts by weight, about 9-11 parts by weight, about 9.0-10.5 parts by weight, about 10.2 parts by weight, or about 9.2 parts by weight of component (C). In some embodiments, based on 100 parts by weight of component (A), the thermoplastic vulcanizate may include about 0.2-2.9 parts by weight, about 0.25-2.85 parts by weight, about 0.30-2.75 parts by weight, about 0.40-2.70 parts by weight, about 0.45 parts by weight, about 2.45 parts by weight, or about 2.675 parts by weight of component (D). In some embodiments, based on 100 parts by weight of component (A), the thermoplastic vulcanizate may include about 5.5-50 parts by weight, about 10-50 parts by weight, about 6.0-49.5 parts by weight, about 16.0-49.0 parts by weight, about 6.45 parts by weight, about 7.16 parts by weight, about 16.45 parts by weight, or about 48.95 parts by weight of component (E). In some embodiments, based on 100 parts by weight of component (A), the thermoplastic vulcanizate may include about 0-20 parts by weight, about 5-15 parts by weight, about 10-12 parts by weight, or about 11.4 parts by weight of component (F).

In an embodiment, component (B) may be a continuous phase, and component (A) may be a dispersed phase dispersed in component (B). The above feature can be observed by a scanning electron microscope (SEM). Specifically, after obtaining a SEM image of the thermoplastic vulcanizate of the present disclosure by a scanning electron microscope, it can be observed from the obtained SEM image that the thermoplastic vulcanizate of the present disclosure has a continuous phase and a dispersed phase. The dispersed phase is dispersed in the continuous phase in the form of a plurality of particles. In some embodiments, component (A) includes spherical particles with a particle size of about 0.5 to 10 μm. In some embodiments, component (A) includes spherical particles with a particle size of about 0.5 to 5 μm. In the disclosure, the particle size of the particles of the dispersed phase is obtained by calculating an average particle size of the spherical particles from the obtained SEM image using an image processing software.

The thermoplastic vulcanizate of the present disclosure including the above features may have a Shore A hardness of about 45-80, an abrasion amount of about 50-250 mg based on the DIN 53516 standard, and a wet slip resistance coefficient of about 0.25-0.45 based on the F1677 standard. In some embodiments, the thermoplastic vulcanizate of the present disclosure has a Shore A hardness of about 50-75, about 50-70, or about 55-65. In some embodiments, the thermoplastic vulcanizate of the present disclosure has an abrasion amount of about 80-250 mg, about 90-250 mg, or about 100-250 mg. In some embodiments, the t thermoplastic vulcanizate of the present disclosure has a wet slip resistance coefficient of about 0.28-0.45, about 0.30-0.43, or about 0.33-0.40.

In summary, the thermoplastic vulcanizate of the present disclosure has a better wear resistance and a better wet slip resistance. Therefore, the thermoplastic vulcanizate of the present disclosure may be applied to any field requiring high wear resistance and high wet slip resistance. In some embodiments, the thermoplastic vulcanizate of the present disclosure is suitable for shoe soles, sporting goods, building materials and industrial materials, but the present disclosure is not limited thereto.

The components (A)-(F) in the thermoplastic vulcanizate of the present disclosure are further described below.

(A) Styrene Copolymer Rubber

The styrene copolymer rubber in the thermoplastic vulcanizate of the present disclosure may be any copolymer including a styrene group. In some embodiments, the styrene copolymer rubber includes a cross-linked styrene copolymer having a high slip resistance. Examples of the styrene copolymer rubber may include solution-polymerized styrene-butadiene rubbers (SSBR), emulsion-polymerized styrene-butadiene rubbers (ESBR), styrene-ethylene-butylene-styrene (SEBS) rubbers, styrene-ethylene-propylene-styrene (SEPS) rubbers, styrene-butadiene (SB) rubbers, styrene-isoprene-styrene (SIS) rubbers, styrene-butadiene-styrene or any combination thereof, but the present disclosure is not limited thereto.

The SSB rubbers have characteristics of a good wear resistance, a good color quality, and a good wet slip resistance. The EBS rubbers have characteristics of a good wear resistance, a low production cost, and a good wet slip resistance. The SEBS rubbers have characteristics of a high strength, a good ozone and ultraviolet resistance, a good thermal stability, a good heat resistance, and a good toughness. The SEPS rubbers have characteristics of a good heat resistance and a good oxidation resistance. The SB rubbers have characteristics of a good aging resistance, a good heat resistance, and a good wear resistance. The SIS rubbers have characteristics of a good softness and a high elasticity. The SBS rubbers have characteristics of a high strength, a high transparency, and a good tensile strength. Person having ordinary skill in the art may select the type of the styrene copolymer rubber and adjust the proportion and content of the styrene copolymer rubber to be used according to their needs.

For example, if a thermoplastic vulcanizate with a better wear resistance is desired, the styrene copolymer rubber may include the SB rubbers, the SSB rubbers, the ESB rubbers or any combination thereof, or the content of the SB rubbers, the SSB rubbers, the ESB rubbers or any combination thereof may be increased. If a thermoplastic vulcanizate with a greater strength is desired, the styrene copolymer rubber may include the SEBS rubbers, or the content of the SEBS rubbers may be increased. If a thermoplastic vulcanizate with a greater strength is desired, the styrene copolymer rubber may include only the SEBS rubbers, or the content of the SEBS rubbers may be increased. However, the present disclosure is not limited thereto.

In some embodiments, the styrene copolymer rubber may include the SSB rubbers, the ESB rubbers, the SB rubbers, the SEBS rubbers, the SEPS rubbers, the SIS rubbers or any combination thereof, but the disclosure is not limited thereto. In some embodiments, the styrene copolymer rubber may include the SSB rubbers, the ESB rubbers, the SB rubbers, the SEBS rubbers or any combination thereof, but the present disclosure is not limited thereto.

(B) Thermoplastic Elastomer

The thermoplastic elastomer in the thermoplastic vulcanizate of the present disclosure may include any thermoplastic elastomer having high polarity. In some embodiments, the thermoplastic elastomer may include thermoplastic polyamide elastomers (TPAE), thermoplastic polyetherester elastomers (TPEE), or a combination thereof. In some embodiments, the thermoplastic elastomer may include thermoplastic polyamide elastomers, polyether type polyester elastomers, polyester type polyester elastomers or any combination thereof.

In some embodiments, the thermoplastic elastomer may include the thermoplastic polyamide elastomers, the polyether type polyester elastomers, and the polyester type polyester elastomers with a Shore D hardness of about 25 to 50, or any combination thereof. In some embodiments, the thermoplastic elastomer may include the polyether type polyester elastomers and/or the polyester type polyester elastomers with a Shore D hardness of about 25-50. When the Shore D hardness is less than about 25, the elastomer is too soft, which may result in insufficient strength of the subsequently formed thermoplastic vulcanizate. When the Shore D hardness is higher than about 50, the elastomer is too hard, which may result in a poor anti-slip performance of the subsequently formed thermoplastic vulcanizate.

The thermoplastic polyamide elastomer mentioned above refers to a block copolymer composed of a hard segment comprising amides and a soft segment comprising polyethers or polyesters. Examples of the amides of the hard segment in the thermoplastic polyamide elastomers may include, but are not limited to, a polycaprolactamide (Nylon 6), a polyamide 66 (PA66), a polylaurolactamide (PA12), and an aromatic polyamide. Examples of the polyesters of the soft segment in the thermoplastic polyamide elastomer may include, but are not limited to, a polyglycolide (PGA), a polylactide (PLA), and a polycaprolactone diol. Examples of the polyethers of the soft segment in the thermoplastic polyamide elastomer may include, but are not limited to, a polytetramethylene ether glycol (PTMEG), a polyethylene glycol ether, and a poly(propylene glycol) diglycidyl ether.

The thermoplastic polyetherester elastomer mentioned above refers to a block copolymer composed of a hard segment comprising polybutylene terephthalates (PBT) and a soft segment comprising polyethers or polyesters. According to the components included in the soft segment, the thermoplastic polyetherester elastomers can be divided into a polyether type polyester elastomer and a polyester type polyester elastomer. Examples of the soft segment of the polyether type polyester elastomer may include, but are not limited to, polytetramethylene ether glycols, polyethylene glycol ethers, and polypropylene glycol ethers. Examples of soft segments of the polyester type polyester elastomer may include, but are not limited to, polyglycolides, polylactides, and polycaprolactones.

(C) Interfacial Compatible Resin

The interfacial compatible resin in the thermoplastic vulcanizate of the present disclosure may include any resin that can make component (A), the styrene copolymer rubbers, compatible with component (B), the thermoplastic elastomers. In some embodiments, the interfacial compatible resin may include maleic anhydride grafted polymers, but the present disclosure is not limited thereto.

Examples of the maleic anhydride grafted polymers may include, but are not limited to, maleic anhydride grafted polyethylenes (PE-MAH), maleic anhydride grafted ethylene-vinyl acetate copolymers (EVA-MAH), maleic anhydride grafted polyolefin elastomers (POE-MAH), maleic anhydride grafted EPDM rubbers (EPDM-MAH), maleic anhydride grafted styrene-ethylene-butylene-styrene rubbers (SEBS-MAH), and styrene maleic anhydrides (SMA), but the disclosure is not limited thereto.

In some embodiments, a graft rate of the maleic anhydride grafted polymer is about 0.3-2.0%. When the graft rate of the maleic anhydride grafted polymer is less than about 0.3%, component (B), the thermoplastic elastomers, cannot undergo a complete grafting reaction smoothly, and the compatibility of component (B) and component (A), the styrene copolymer rubbers, cannot be improved. Therefore, a compatibility between component (B) and component (A) is too low to be well compatible. When the graft rate of the maleic anhydride grafted polymer is higher than about 2.0%, component (A) and component (B) will be excessively compatible, which will affect the subsequent dynamic cross-linking phase inversion behavior.

(D) Cross-Linking Formulation

The cross-linking formulation in the thermoplastic vulcanizate of the present disclosure includes any formulation that can make component (A) and component (B) undergo a dynamic cross-linking reaction. In some embodiments, the cross-linking formulation may include a cross-linking agent and a cross-linking assistant, but the present disclosure is not limited thereto.

Examples of the cross-linking agent mentioned above may include a 2,5-bis(tert-butylperoxy)-2,5-dimethylhexane, dicumyl peroxide (DCP), a benzoyl peroxide, a di-tert-butyl peroxide, or any combination thereof, but the present disclosure is not limited thereto. Examples of the cross-linking assistant mentioned above may include a trimethylolpropane trimethacrylate (TMPTMA), a triallyl isocyanurate (TAIL), a trimethylolpropane triacrylate (TMPTA), a triallyl cyanurate (TAC), a triallyl phosphate (TAP), a triallyl borate (TAB), or any combination thereof, but the disclosure is not limited thereto.

(E) Additive

The additive in the thermoplastic vulcanizates of the present disclosure may include any additives for reinforcing the thermoplastic vulcanizates or providing desired functional properties to the thermoplastic vulcanizates. The additive may be any additives that does not adversely affect the dynamic cross-linking reaction of component (A) and component (B) of the thermoplastic vulcanizates. In some embodiments, examples of the additive may include reinforcing additives, antioxidants, plasticizers, silane coupling agents or any combination thereof, but the disclosure is not limited thereto.

The reinforcing additives may be any compounds that can improve mechanical properties and/or a chemical resistance of the thermoplastic vulcanizate. In some embodiments, the reinforcing additives may include carbonaceous materials, such as a carbon black, a white carbon black, graphene materials or any combination thereof, but the present disclosure is not limited thereto.

The antioxidants can avoid and/or reduce a deterioration of the thermoplastic vulcanizates caused by light, heat, mechanical shear force, etc. during a manufacturing process thereof and in the environment. In some embodiments, the antioxidants may include phenolic antioxidants and phosphorus antioxidants, or any combination thereof, but the present disclosure is not limited thereto. Examples of the phenolic antioxidants may include, but are not limited to, a 2,6-di-tert-butylphenol, a 2,6-di-tert-butyl-4-ethylphenol, a 2,6-di-tert-butyl-4-methylphenol, a 4-hydroxymethyl-2,6-di-tert-butylphenol, and a 2,4-dimethyl-6-tert-butylphenol. Examples of the phosphorus antioxidants may include, but are not limited to, a tris(2,4-di-tert-butylphenyl) phosphite and a tris(nonylphenyl) phosphite.

The plasticizers can increase a softness of the thermoplastic vulcanizates. In some embodiments, the plasticizers may include petroleum based plasticizers, non-petroleum based plasticizers or a combination thereof. Examples of the petroleum based plasticizers include, but are not limited to, paraffinic oils, naphthenic oils, or aromatic oils. Examples of the non-petroleum based plasticizers include, but are not limited to, glutarates and adipates.

The silane coupling agents can improve mechanical properties, a heat resistance, a water resistance and a weather resistance of the thermoplastic vulcanizates. In some embodiments, the silane coupling agents may include but not limited to a vinyltrichlorosilane (VTC), a vinyltriethoxysilane, (3-chloropropyl) trimethoxysilane, and a (3-chloropropyl) triethoxysilane, but the present disclosure is not limited thereto.

(F) Non-Aromatic Rubber

The non-aromatic rubber in the thermoplastic vulcanizate of the present disclosure is a rubber which does not include an aromatic group. Examples of the non-aromatic rubber may include butadiene rubbers (BR), butyl rubbers (IIR), bromobutyl rubbers (BIIR), natural rubbers (NR), or any combination thereof, but the present disclosure does not limited to this. In some embodiments, the non-aromatic rubber includes the butadiene rubbers, the butyl rubbers, or a combination thereof. The non-aromatic rubber can further improve properties, such as a wear resistance, a weather resistance and a compression set resistance of the thermoplastic vulcanizate.

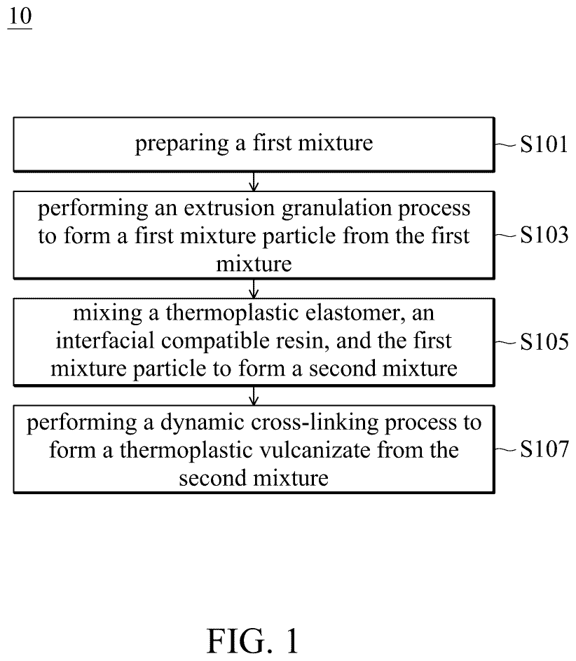

The disclosure further provides a preparation method of a thermoplastic vulcanizate. FIG. 1 is a flowchart of a preparation method 10 of a thermoplastic vulcanizate according to an embodiment of the present disclosure. As shown in FIG. 1, the preparation method 10 includes a step S101 of preparing a first mixture; a step 103 of performing an extrusion granulation process to form a first mixture particle from the first mixture; a step 105 of mixing a thermoplastic elastomer, an interfacial compatible resin, and the first mixture particle to form a second mixture; and step S107 of performing a dynamic cross-linking process to form a thermoplastic vulcanizate from the second mixture. The steps S101 to S107 are further described below.

The step S101 of preparing the first mixture includes feeding a rubber and a cross-linking formulation into an internal mixer to form the first mixture including the rubber and the cross-linking formulation, but the disclosure is not limited thereto. In an embodiment, the rubber may include styrene copolymer rubbers such as that recited for component (A) mentioned above and non-aromatic rubbers such as that recited for component (F) mentioned above, and a cross-linking formulation such as that recited for component (D) mentioned above. Therefore, the styrene copolymer rubbers, the non-aromatic rubbers, and the cross-linking formulation will not be repeated here. In an embodiment, a weight ratio of the styrene copolymer rubber such as that recited for component (A) mentioned above to the non-aromatic rubbers such as that recited for component (F) mentioned above is about 8-10:0-2. In some embodiments, a weight ratio of the styrene copolymer rubbers to the non-aromatic rubbers is 9:1.

In an embodiment, in the step S101, about 100-120 parts by weight of the rubber and about 0.2-3 parts by weight of the cross-linking formulation can be feed into the internal mixer. In an embodiment, the rubber includes about 100 parts by weight of the styrene copolymer rubbers and about 0-20 parts by weight of the non-aromatic rubbers. Based on about 100 parts by weight of the styrene copolymer rubbers, in the step S101, about 0.2 to 2.9 parts by weight, about 0.25 to 2.85 parts by weight, about 0.30 to 2.75 parts by weight, about 0.40 to 2.70 parts by weight, about 0.45 parts, about 2.45 parts by weight, or about 2.675 parts by weight of the cross-linking formulation can be feed into the internal mixer.

In an embodiment, the step S101 of preparing the first mixture may further include feeding the additive to the internal mixer. In an embodiment, the additive may include the additives such as that recited for component (E) mentioned above, so details of the additive will not be repeated here. In this embodiment, in the step S101, based on 100 parts by weight of the styrene copolymer rubbers, about 5 to 50 parts by weight, about 5.5 to 50 parts by weight, about 10 to 50 parts by weight, about 6.0 to 49.5 parts by weight, about 16.0-49.0 parts by weight, about 6.45 parts by weight, about 7.16 parts by weight, about 16.45 parts by weight, or about 48.95 parts by weight of the additive can be feed into the internal mixer.

The step 103 of performing the extrusion granulation process to form the first mixture particle from the first mixture includes steps of feeding the first mixture into an extruder, kneading the first mixture at a screw speed of about 50 to 100 rpm, and then extruding and granulating the first mixture to form the first mixture particle. In some embodiments, the extrusion granulation process in the step S103 may include an extrusion temperature of about 60-80° C. In some embodiments, the extruder is a rubber extruder. In some embodiments, examples of the extruder may include, but are not limited to, a kneader, a Banbury mixer, a single-screw extruder and a twin-screw extruder. In an embodiment, the extruder is a twin-screw extruder.

The step S105 of mixing the thermoplastic elastomer, the interfacial compatible resin, and the first mixture particle to form the second mixture includes steps of feeding the thermoplastic elastomer, the interfacial compatible resin, and the first mixture particle obtained from the step S103 into the extruder. In some embodiments, the step 105 further includes a pretreatment step of drying the thermoplastic elastomer at a temperature of about 60-100° C. for about 2-5 hours before mixing the thermoplastic elastomer, the interfacial compatible resin, and the first mixture particle. In some embodiments, examples of the extruder may include, but are not limited to, a kneader, a Banbury mixer, a single-screw extruder and a twin-screw extruder. In an embodiment, the extruder is a twin-screw extruder. In an embodiment, the thermoplastic elastomer may include the thermoplastic elastomers such as that recited for component (B) mentioned above, and the interfacial compatible resin may include the interfacial compatible resins such as that recited for component (C) mentioned above, so details of the thermoplastic elastomer and the interfacial compatible resin will not be repeated here.

In the step S105, in parts by weight, the amount of the thermoplastic elastomer feed into the extruder is less than the content of the rubber in the first mixture particles. In an embodiment, based on 100 parts by weight of the styrene copolymer rubber of the first mixture particle, the thermoplastic elastomer and the interfacial compatible resin feed into the extruder can be about 40 to 90 parts by weight and about 5 to 15 parts by weight, respectively. That is, in the embodiment in which the first mixture particle does not include the additive, the thermoplastic elastomer, the interfacial compatible resin, and the first mixture particle may be mixed in the ratio of about 40 to 90 parts by weight of the thermoplastic elastomer, about 5 to 15 parts by weight of the interfacial compatible resin and about 100.2-123 parts by weight of the first mixture particle. In the embodiment in which the first mixture particle includes the additive, the thermoplastic elastomer, the interfacial compatible resin, and the first mixture particle can be mixed in the ratio of about 40 to 90 parts by weight of the thermoplastic elastomer, about 5 to 15 parts by weight of the interfacial compatible resin and about 105.2-173 parts by weight of the first mixture particle.

The step S107 of performing the dynamic cross-linking process to form the thermoplastic vulcanizate from the second mixture includes performing the dynamic cross-linking process at a screw speed of about 150-300 rpm and a reaction temperature of about 170-200° C. In an embodiment, the dynamic cross-linking process is performed in the extruder described in the step S105 after the second mixture is obtained from the step S105. In some embodiments, the step S107 further includes a step of performing an extrusion granulation process to form the thermoplastic vulcanizate particle from the thermoplastic vulcanizate. In some embodiments, the extrusion granulation process may include an extrusion temperature of 160-200° C. In some embodiments, the step 107 further includes a drying step of drying the thermoplastic vulcanizate particle at a temperature of about 80-120° C. for about 6-10 hours.

The thermoplastic vulcanizate prepared by the preparation method mentioned above may have a Shore A hardness of about 45-80, an abrasion amount of about 50-250 mg based on the DIN 53516 standard, and a wet slip resistance coefficient of about 0.25-0.45 based on the F1677 standard. In some embodiments, the thermoplastic vulcanizate prepared by the preparation method mentioned above may have a Shore A hardness of about 50-75, about 50-70, or about 55-65. In some embodiments, the thermoplastic vulcanizate prepared by the preparation method mentioned above may have an abrasion amount of about 80-250 mg, about 90-250 mg, or about 100-250 mg. In some embodiments, the thermoplastic vulcanizate prepared by the preparation method mentioned above may have a wet slip resistance coefficient of about 0.28-0.45, about 0.30-0.43, or about 0.33-0.40. The present disclosure further provides a thermoplastic vulcanizate prepared by the preparation method mentioned above.

In summary, the thermoplastic vulcanizate prepared by the preparation method mentioned above may have a better wear resistance and a better wet slip resistance. Therefore, the thermoplastic vulcanizate prepared by the preparation method mentioned above may be applied to any field requiring high wear resistance and high wet slip resistance. In some embodiments, the thermoplastic vulcanizate prepared by the preparation method mentioned above is suitable for shoe soles, sporting goods, building materials and industrial materials, but the present disclosure is not limited thereto.

Specific examples of the present disclosure are provided below to further illustrate advantages of the present disclosure over prior arts, but the advantages of the present disclosure are not limited thereto.

Materials and equipment used in the specific examples of the present disclosure are as follows.

Rubber

SSBR: solution-polymerized styrene-butadiene (SSB) rubbers, purchased from TSRC Corporation, model: TAIPOL 1453.
SEBS: styrene-ethylene-butylene-styrene rubbers, purchased from TSRC Corporation, model: TAIPOL 6014.
BR: butadiene rubbers, purchased from TSRC Corporation, model: TAIPOL 0150.
IIR: butyl rubbers, purchased from FUH TAI TRADING CO., LTD., model: BUTYL 065.

Cross-Linking Formulation

TAIL: triallyl isocyanurates, used as a cross-linking assistant, purchased from GO YEN CHEMICAL INDUSTRIAL CO., LTD., model: GY-TAIC70.
TMPTMA: trimethylolpropane trimethacrylates, used as a cross-linking assistant, purchased from DOUBLE BOND CHEMICAL IND. CO., LTD., model: DOUBLEMER TMPTMA.
DCP: dicumyl peroxides, used as a cross-linking agent, purchased from GO YEN CHEMICAL INDUSTRIAL CO., LTD., model: GY-DCP.

Additive

AO1050: an antioxidant, purchased from AN FONG DEVELOPMENT CO., LTD.
Silica: a reinforcing additive, purchased from PEI LONG ENTERPRISE CO., LTD., model: Hi-Sil 255.
Si69: a silane coupling agent, purchased from GO YEN CHEMICAL INDUSTRIAL CO., LTD.
Paraffin oil: purchased from Emperor Chemical Co., Ltd., model: EP paraffin oil.

Thermoplastic Elastomer

TPEE: polyester type polyester elastomers, purchased from Dutch State Mines (DSM), model: EL150.

Interfacial Compatible Resin

SMA: styrene maleic anhydrides, purchased from YUANG HONG CORPORATION, model: SMA1000.
SEBS-MAH: maleic anhydride grafted styrene-ethylene-butylene-styrene rubbers, purchased from ANCHEM TECHNOLOGY CORPORATION, model: ANP-7131.

Internal Mixer: purchased from WELL SHYANG MACHINERY CO., LTD., model: SKM-20L.

A first extruder: a twin-screw extruder, purchased from Coperion Gmbh, model: ZSK25. The ratio (L/D) of an effective length of a screw to a diameter of the screw is 40, and a helix angle ψ is 25.

A second extruder: a twin-screw extruder, purchased from Coperion Gmbh, model: ZSK26. The ratio (L/D) of an effective length of a screw to a diameter of the screw is 60, and the helix angle ψ is 26.

Preparation methods of Comparative Example 1-4 and Example 1-11 are as follows.

A rubber, a cross-linking formulation, and an additive mentioned above were feed into the internal mixer to obtain a first mixture in parts by weight shown in Table 1 and Table 2.

The first mixture was feed into a first extruder, and the first mixture was kneaded and forced granulation at an extrusion temperature of about 60-80° C. and a screw speed of about 50-100 rpm to form a first mixture particle.

A thermoplastic elastomer particle was dried at about 80° C. for about 3 to 4 hours. Based on 100 parts by weight of the styrene copolymer rubber in the first mixture particle, the dried thermoplastic elastomer particle, the first mixture particle, and an interfacial compatible resin were feed into a second extruder in parts by weight shown in Table 1 and Table 2 to form a second mixture. A dynamic cross-linking reaction was performed at a screw speed of about 150-300 rpm and a reaction temperature of about 170-200° C. to form a thermoplastic vulcanizate from the second mixture. An extrusion granulation process was performed at an extrusion temperature of 160-200° C. to form a thermoplastic vulcanizate particle from the vulcanizate. The obtained thermoplastic vulcanizate particle was dried at about 80-100° C. for about 6-8 hours to complete the preparation of the thermoplastic vulcanizate particle of Comparative Examples 1-4 and Examples 1-11.

TABLE 1

| composition | | | | | | | |
|---|---|---|---|---|---|---|---|
| (parts by | Comparative | Comparative | Comparative | Comparative | Example | Example | Example |
| weight) | Example 1 | Example 2 | Example 3 | Example 4 | 1 | 2 | 3 |
| SSBR | 100 | 100 | 100 | 100 | 100 | 100 | 100 |
| SEBS | — | — | — | — | — | — | — |
| BR | — | — | — | — | — | — | — |
| IIR | — | — | — | — | — | — | — |
| TPEE | 75 | 75 | 75 | 75 | 75 | 75 | 75 |
| SMA | 9.2 | 9.2 | 9.2 | 9.2 | 9.2 | 9.2 | 9.2 |
| SEBS-MAH | — | — | — | — | — | — | — |
| TAIC | — | 2.0 | — | — | — | — | — |
| TMPTMA | — | — | — | — | — | 2.0 | 2.0 |
| DCP | — | — | — | — | 0.45 | 0.45 | 0.675 |
| AO1050 | 1.45 | 1.45 | 1.45 | 1.45 | 1.45 | 1.45 | 1.45 |
| Silica | — | — | 30 | 30 | — | — | — |
| Si69 | — | — | — | — | — | — | — |
| Paraffin oil | — | — | — | 5 | 5 | 5 | 5 |

TABLE 2

| composition | | | | | | | | |
|---|---|---|---|---|---|---|---|---|
| (parts by | Example | Example | Example | Example | Example | Example | Example | Example |
| weight) | 4 | 5 | 6 | 7 | 8 | 9 | 10 | 11 |
| SSBR | 100 | 90 | 100 | 100 | 100 | 100 | 100 | 100 |
| SEBS | — | 10 | — | — | — | — | — | — |
| BR | — | — | 11.1 | — | — | — | — | — |
| IIR | — | — | — | 11.1 | — | — | — | — |
| TPEE | 75 | 75 | 83.3 | 83.3 | 75 | 75 | 90 | 75 |
| SMA | 9.2 | 9.2 | 10.2 | 10.2 | 9.2 | 9.2 | 9.2 | — |
| SEBS-MAH | — | — | — | — | — | — | — | 9.2 |
| TAIC | 2.0 | — | — | — | — | — | — | — |
| TMPTMA | — | 2.0 | 2.2 | 2.2 | 2.0 | 2.0 | 2.0 | 2.0 |
| DCP | 0.45 | 0.45 | 0.5 | 0.5 | 0.45 | 0.45 | 0.45 | 0.45 |
| AO1050 | 1.45 | 1.45 | 1.61 | 1.61 | 1.45 | 1.45 | 1.45 | 1.45 |
| Silica | — | — | — | — | — | 30 | 30 | 30 |
| Si69 | — | — | — | — | — | 2.5 | 2.5 | 2.5 |
| Paraffin oil | 5 | 5 | 5.55 | 5.55 | 15 | 15 | 15 | 15 |

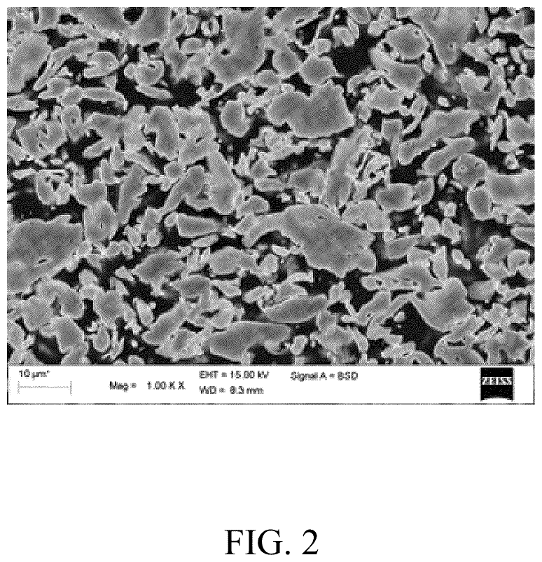

SEM images of the thermoplastic vulcanizate particles of Examples 1-11 were obtain using a scanning electron microscope (manufacturer: FEI (Thermo Fisher Scientific), model: Talos F200XG2). FIG. 2 is a SEM image of the thermoplastic vulcanizate particle according to Example 8 of the present disclosure. It can be seen from the SEM image of FIG. 2, the rubber was dispersed in the thermoplastic polyetherester elastomer in the form of spherical particles. Boundaries of the spherical particles were processed by an image processing software. Analyze an average particle size based on the SEM images of Examples 1-11 to obtain a particle size of particle is about 0.5-10 μm.

Shore A hardness of the thermoplastic vulcanizate particles of Comparative Examples 1-4 and Examples 1-11 were measured using a Type A Shore hardness meter (manufacturer: Teclock, model: Shore A). Tensile strength of the thermoplastic vulcanizate particles of Comparative Examples 1-4 and Examples 1-11 were measured using a universal tensile testing machine (manufacturer: Chuanhua Precision, model: EJA Vantage). Elongation of the thermoplastic vulcanizate particles of Comparative Examples 1-4 and Examples 1-11 were measured using a universal tensile testing machine (manufacturer: Chuanhua Precision, model: EJA Vantage). Abrasion amount of the thermoplastic vulcanizate particles of Comparative Examples 1-4 and Examples 1-11 were measured using a DIN abrasion tester (manufacturer: COMETECH TESTING MACHINES CO., LTD., model: QC-618A) based on the DIN 53516 standard. Dry slip resistance coefficients of the thermoplastic vulcanizate particles of Comparative Examples 1-4 and Examples 1-11 were measured using a portable toggle anti-slip testing machine (manufacturer: Suzhou Zhongming Instrument Co., Ltd., model: TNL108MARK-2). Wet slip resistance coefficients of the thermoplastic vulcanizate particles of Comparative Examples 1-4 and Examples 1-11 were measured using portable toggle anti-slip testing machine (manufacturer: Suzhou Zhongming Instrument Co., Ltd., model: TNL108MARK-2) based on F1677 standard. The measurement results are listed in Table 3 and Table 4 below.

TABLE 3

| | Comparative | Comparative | Comparative | Comparative | Example | Example | Example |
|---|---|---|---|---|---|---|---|
| Item | Example 1 | Example 2 | Example 3 | Example 4 | 1 | 2 | 3 |
| Hardness | 52 | 52 | 57 | 56 | 57 | 58 | 60 |
| (Shore A) | | | | | | | |
| Tensile | 58.6 | 55.6 | 65.8 | 64.0 | 92.8 | 93.6 | 102.5 |
| strength | | | | | | | |
| (kg/cm²) | | | | | | | |
| Elongation | 720 | 700 | 412 | 459 | 540 | 592 | 426 |
| (%) | | | | | | | |
| Abrasion | 424 | 425 | 325 | 316 | 248 | 185 | 159 |
| amount | | | | | | | |
| (mg) | | | | | | | |
| Dry slip | >1 | >1 | 0.89 | 0.91 | >1 | >1 | 0.85 |
| resistance | | | | | | | |
| coefficient | | | | | | | |
| Wet slip | 0.23 | 0.21 | 0.18 | 0.21 | 0.39 | 0.38 | 0.36 |
| resistance | | | | | | | |
| coefficient | | | | | | | |

TABLE 4

| | Example | Example | Example | Example | Example | Example | Example | Example |
|---|---|---|---|---|---|---|---|---|
| Item | 4 | 5 | 6 | 7 | 8 | 9 | 10 | 11 |
| Hardness | 58 | 57 | 56 | 60 | 55 | 65 | 65 | 64 |
| (Shore A) | | | | | | | | |
| Tensile | 86.5 | 89.5 | 78.6 | 90.5 | 91.6 | 96.7 | 71.5 | 89.4 |
| strength | | | | | | | | |
| (kg/cm²) | | | | | | | | |
| Elongation | 620 | 485 | 612 | 558 | 511 | 456 | 720 | 467 |
| (%) | | | | | | | | |
| Abrasion | 192 | 175 | 216 | 225 | 146 | 85 | 102 | 116 |
| amount | | | | | | | | |
| (mg) | | | | | | | | |
| Dry slip | >1 | 0.90 | 0.89 | 0.86 | 0.92 | 0.98 | 0.93 | 0.95 |
| resistance | | | | | | | | |
| coefficient | | | | | | | | |
| Wet slip | 0.35 | 0.36 | 0.35 | 0.35 | 0.38 | 0.40 | 0.37 | 0.39 |
| resistance | | | | | | | | |
| coefficient | | | | | | | | |

It can be seen from the measurement results in Table 3 and Table 4 that each of the thermoplastic vulcanizates of Comparative Examples 1-4 has an abrasion amount of more than about 300 mg and a wet slip coefficient of less than about 0.25. Each of the thermoplastic vulcanizates of Examples 1 to 11 of the present disclosure has an abrasion amount of about 250 mg or less and a wet slip resistance coefficient of about 0.35 or more. Each of the thermoplastic vulcanizates of Examples 8 to 11 has an abrasion amount of about 150 mg or less. Each of the thermoplastic vulcanizates of Examples 9 to 11 including the reinforcing additive may even has an abrasion amount of about 120 mg or less.

It can be seen from the above measurement results show that, compared with the thermoplastic vulcanizate of Comparative Examples, the thermoplastic vulcanizate of the present disclosure has a better wear resistance and a better wet slip resistance. Therefore, the thermoplastic vulcanizate of the present disclosure may be applied to any field requiring high wear resistance and high wet slip resistance. In some embodiments, the thermoplastic vulcanizate of the present disclosure is suitable for shoe soles, sporting goods, building materials and industrial materials, but the present disclosure is not limited thereto.

While the disclosure has been described by way of example and in terms of the preferred embodiments, it should be understood that the disclosure is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A thermoplastic vulcanizate, comprising:
(A) 100 parts by weight of a styrene copolymer rubber;
(B) 40-90 parts by weight of a thermoplastic elastomer;
(C) 5-15 parts by weight of an interfacial compatible resin; and
(D) 0.2-3 parts by weight of a cross-linking formulation,
wherein the content of component (A) is greater than the content of component (B), and component (A) is dispersed in component (B) in a form of particles with a particle size of about 0.5-10 μm.

2. The thermoplastic vulcanizate as claimed in claim 1, wherein component (A) is dispersed in component (B) in the form of particles with a particle size of about 0.5-5 μm.

3. The thermoplastic vulcanizate as claimed in claim 1, wherein component (A) comprises solution-polymerized styrene-butadiene rubbers (SSBR), emulsion-polymerized styrene-butadiene rubbers (ESBR), styrene-ethylene-butylene-styrene (SEBS) rubbers, styrene-ethylene-propylene-styrene (SEPS) rubbers, styrene-butadiene (SB) rubbers, styrene-isoprene-styrene (SIS) rubbers, styrene-butadiene-styrene or any combination thereof.

4. The thermoplastic vulcanizate as claimed in claim 1, wherein component (B) comprises thermoplastic polyamide elastomers (TPAE), thermoplastic polyetherester elastomers (TPEE), or a combination thereof.

5. The thermoplastic vulcanizate as claimed in claim 1, wherein component (C) comprises maleic anhydride grafted polymers.

6. The thermoplastic vulcanizate as claimed in claim 1, wherein component (D) comprises a cross-linking agent and a cross-linking assistant.

7. The thermoplastic vulcanizate as claimed in claim 6, wherein the cross-linking agent comprises a 2,5-bis(tert-butylperoxy)-2,5-dimethylhexane, a dicumyl peroxide (DCP), a benzoyl peroxide, a di-tert-butyl peroxide, or any combination thereof.

8. The thermoplastic vulcanizate as claimed in claim 1, wherein the cross-linking assistant comprises a trimethylolpropane trimethacrylate (TMPTMA), a triallyl isocyanurate (TAIL), a trimethylolpropane triacrylate (TMPTA), a triallyl cyanurate (TAC), a triallyl phosphate (TAP), a triallyl borate (TAB), or any combination thereof.

9. The thermoplastic vulcanizate as claimed in claim 1, further comprising (E) 5-50 parts by weight of an additive.

10. The thermoplastic vulcanizate as claimed in claim 9, wherein the additive comprises reinforcing additives, antioxidants, plasticizers, silane coupling agents or any combination thereof.

11. The thermoplastic vulcanizate as claimed in claim 1, further comprising (F) 0-20 parts by weight of a non-aromatic rubber.

12. The thermoplastic vulcanizate as claimed in claim 11, wherein the non-aromatic rubber comprises butadiene rubbers (BR), butyl rubbers (IIR), bromobutyl rubbers (BIIR), natural rubbers (NR), or any combination thereof.

13. The thermoplastic vulcanizate as claimed in claim 11, a weight ratio of component (A) to component (F) mentioned above is about 8-10:0-2.

14. A preparation method of a thermoplastic vulcanizate, comprising the following steps:
preparing a first mixture, wherein the first mixture comprises a styrene copolymer rubber and a cross-linking formulation;
performing an extrusion granulation process to form a first mixture particle from the first mixture;
mixing a thermoplastic elastomer, an interfacial compatible resin, and the first mixture particle to form a second mixture, wherein in parts by weight, the content of the rubber in the first mixture particle is more than that of the thermoplastic elastomer; and
performing a dynamic cross-linking process to form a thermoplastic vulcanizate from the second mixture,
wherein the dynamic cross-linking process is performed at a reaction temperature of about 170-200° C. and a screw speed of about 150-300 rpm.

15. The preparation method of a thermoplastic vulcanizate as claimed in claim 14, wherein the second mixture comprises 100.2-123 parts by weight of the first mixture particle, 40 to 90 parts by weight of the thermoplastic elastomer, and 5 to 15 parts by weight of the interfacial compatible resin.

16. The preparation method of a thermoplastic vulcanizate as claimed in claim 14, wherein the first mixture further comprises an additive.

17. The preparation method of a thermoplastic vulcanizate as claimed in claim 16, wherein the additive comprises reinforcing additives, antioxidants, plasticizers, silane coupling agents or any combination thereof.
